(19) United States
(12) Patent Application Publication
(10) Pub. No.: US 2010/0165103 A1
(43) Pub. Date: Jul. 1, 2010

(54) Camera Monitoring Systems And Methods For Electromagnetic Dryer Applicators

(76) Inventor: Paul Andreas Adrian, Weselberg (DE)

Correspondence Address: CORNING INCORPORATED, SP-TI-3-1, CORNING, NY, 14831, US

(21) Appl. No.: 12/346,355

(22) Filed: Dec. 30, 2008

(51) Int. Cl. H04N 7/18

(52) U.S. Cl. 348/143; 348/E07.085

(57) ABSTRACT

Camera monitoring systems (100) and methods for monitoring the drying of greenware (22) in an electromagnetic (EM) dryer applicator (12) are disclosed. At least one illuminator (120) is arranged relative to the applicator and provides visible illumination light (124) to the applicator interior (16) through at least one corresponding EM-reflective side window (200) to form an interior illuminated region (161) through which the greenware pass. A camera unit (110) is arranged relative to the applicator and to a camera opening (170S′) formed therein. The camera unit includes a housing (250) with an EM-blocking channel section (320) configured to substantially block EM radiation (36) from reaching the camera lens (260). The camera unit captures electronic images (SI) of the greenware as they pass through the illuminated region. The electronic images having sufficient resolution to resolve at least one greenware drying defect (400). At least one display (140) is used to display the electronic images.

### FIELD

The present invention relates to the electromagnetic drying of ceramic greenware, and in particular relates to camera monitoring systems and methods for electromagnetic dryer applicators used to dry extruded greenware.

### BACKGROUND

Extruded “greenware” are typically comprised of ceramic-forming components that form rigid ceramic bodies (“ware”) when fired at high temperature. Immediately after extrusion, the greenware contains some water, and typically at least some of the water must be removed via a drying process prior to the high-temperature firing.

One method of greenware drying involves passing the greenware through one or more dryer applicators that subject the greenware to radio frequency (RF) or microwave (MW) electromagnetic (EM) radiation.

Changes to the extrusion process (e.g., a die change, skin-flow hardware change, a change in batch formulation, altering of the batch water content, etc.) can cause changes in the drying process that can adversely affect the quality of the dried greenware and of the resulting fired ware. Typical adverse drying effects are either skin-related (i.e., affect the outer layer of the greenware) or geometry related, such as the bowing (bending) of the greenware. Improper drying leads to ware production losses.

The usual method of measuring dried greenware quality involves cutting the greenware and inspecting it. While effective, this process can delay ware production.

### SUMMARY

One aspect of the invention is a camera monitoring system for monitoring the drying of greenware in an applicator having a housing that defines an applicator interior and that employs MW or RF EM radiation. The system includes at least one illuminator arranged relative to the applicator housing and configured to provide illumination to the applicator interior through at least one corresponding EM-reflective side window to form an illuminated region within the applicator interior through which the greenware pass. The system also includes a camera unit arranged relative to the applicator housing. The camera unit is aligned with an opening formed in the housing and is operable to capture electronic images of the greenware as they pass through the interior illuminated region. The electronic images have sufficient resolution to resolve at least one greenware drying defect. The system also includes at least one display operably connected to the camera unit and operable to display one or more of the electronic images.

Another aspect of the invention is a method of monitoring the drying of greenware using MW or RF EM radiation in an applicator having a housing that defines an applicator interior. The method includes forming an illuminated region in the applicator interior by passing illumination from outside the applicator housing through at least one EM-reflecting window of the applicator housing. The method also includes arranging a camera unit having an image sensor and a camera lens outside of the applicator and adjacent an opening in the applicator housing so that the camera unit is in optical communication with the illuminated region through an EM-blocking structure that substantially prevents EM radiation from reaching the camera lens. The method further includes passing the greenware through the illuminated region. The method also includes capturing and displaying electronic images of the greenware as they pass through the illuminated region, with the electronic images having a resolution capable of resolving at least one greenware drying defect.

Another aspect of the invention is a camera monitoring system for a monitoring the drying of greenware in an applicator having a housing with a side, a top and an interior, and that uses MW or RF EM radiation. The system includes side and top illuminators respectively arranged adjacent the applicator housing side and top and respectively operatively configured to provide illumination to the applicator interior through respective EM-reflective side and top windows to form an interior illuminated region through which the greenware pass while being exposed to the EM radiation. The system includes a camera unit arranged adjacent the side illuminator and aligned with an opening formed in the housing. The camera unit is positioned and adapted to capture electronic images of the greenware as they pass through the interior illuminated region. The electronic images having sufficient resolution to resolve at least one greenware drying defect. The system also includes at least one display operably connected to the camera unit and configured to display one or more of the electronic images.

These and other advantages of the invention will be further understood and appreciated by those skilled in the art by reference to the following written specification, claims and appended drawings.

### BRIEF DESCRIPTION OF THE DRAWINGS

FIG. 1 is a schematic diagram of an example greenware-forming system that includes an extruder followed by a two-step drying system that includes first and second electromagnetic (EM) applicators;

FIG. 2 is a schematic diagram of a greenware-forming system similar to that of FIG. 1, but that has a one-step drying system with a single EM applicator;

FIG. 3 is a more detailed side view of the one-step greenware-forming system of FIG. 2;

FIG. 4 is a top-down view of the central section of the conveyor system showing greenware supported in trays and moving through the applicator;

FIG. 5 is a schematic diagram of an example embodiment of the camera monitoring system according to the present invention as shown interfaced with a one-step greenware drying system (top-down view);

FIG. 6 is a close-up, input-end view of the applicator of FIG. 5, showing details of the side and top illuminators and the EM-reflecting windows through which visible illumination light from the illuminators is transmitted and from which EM radiation within the applicator interior is reflected;

FIG. 7 is similar to FIG. 6, but shows the camera unit and only the top illuminator for ease of illustration;

FIG. 8 shows a plan view of an example EM-reflecting window that includes an EM-reflecting screen covered by a glass plate;

FIG. 9 is a close-up cross-sectional view of a portion of an EM reflecting screen showing an example where the holes include a countersink to facilitate the transmission of illumination light through the EM-reflecting screen over a range of angles;

FIG. 10 is a perspective front-end view of an example embodiment of a camera-unit housing for the camera unit, showing the main section and the EM-blocking channel section;

FIG. 11 is a close-up view of the side of the applicator housing as seen from the applicator interior, showing an example configuration of the side illuminator opening with the EM-reflecting window arranged therein, and the adjacent camera opening;

FIG. 12A is a schematic side view of an example “ideal” greenware piece that has no visible drying defects;

FIGS. 12B-12E are similar to FIG. 12A and illustrate different examples of visible drying defects;

FIG. 13A is a schematic diagram of an example displayed image of a greenware piece showing a visible drying defect in the form of a crack or fissure; and

FIG. 13B is similar to FIG. 13A, and illustrates an example displayed image of a greenware piece showing a visible “bow” drying defect, and also showing a projected line formed on the display by the image processor to measure an amount of bow in the piece.

### DETAILED DESCRIPTION

Reference is now made in detail to the embodiments of the invention, examples of which are illustrated in the accompanying drawings. Whenever possible, the same or similar reference numbers and symbols are used throughout the drawings to refer to the same or similar parts.

The camera monitoring system disclosed herein allows for real time monitoring of the drying process that prepares the greenware for firing at high temperature. The real-time monitoring of the drying process by observing drying defects provides very quick feedback (i.e., just a few minutes) to the system operator(s) so that corrective action can be taken to fix the drying problem. The monitoring system can be made automatic using image processing techniques, as described below. The camera monitoring system is applicable to the various know greenware-drying methods. These include, for example, single-step electromagnetic (EM) drying (MW or RF) and two-step EM drying (e.g., MW and RF, MW and MW, RF and RF or RF and MW).

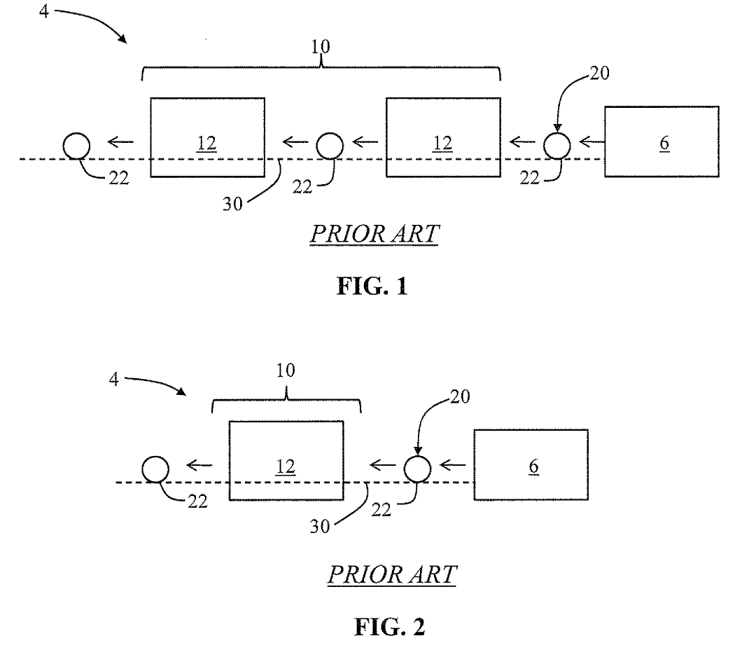

FIG. 1 is a schematic diagram of an exemplary greenware-forming system 4 that includes an extruder 6 followed by a two-step drying system 10 that includes first and second “ovens” or “dryer applicators” 12 (referred to hereinafter as “applicators”) arranged in sequence. The two-step drying system 10 uses any of the aforementioned combinations of MW and/or RF drying steps by suitably arranging applicators 12 to dry pieces 22 of extruded greenware 20 extruded by extruder 6. A conveyor system 30 moves pieces 22 from extruder 6 through applicator 12.

FIG. 2 is a schematic diagram of a greenware-forming system 4 similar to that of FIG. 1, but that shows a one-step drying system 10 having just the one MW or RF applicator 12. The camera monitoring system of present invention is suitable for implementation with various types of greenware-forming systems 4, including one-step and two-step systems such as those shown in FIG. 1 and FIG. 2. In the case of a two-step drying system 10, the camera monitoring system as described below in connection with a one-step drying system is either configured in a straightforward manner to monitor both applicator using two camera units coupled to the camera controller, or is used to monitor just one of the applicators (e.g., the upstream or downstream applicator) using just one camera unit.

Ceramic greenware 20 can be formed by extruding a plasticized batch (not shown) using extruder 6. The batch may comprise, for example, ceramic-forming components, or ceramic precursors, along with a certain amount of water. The batch is extruded through a die, such as a die that produces a honeycomb structure, to form an extrudate of the ceramic-forming material. The extrudate that exits extruder 6 is cut transversely to the direction of extrusion to form the greenware pieces 22. Greenware pieces (hereinafter, “pieces”) 22 may then be transversely cut into shorter pieces. In some cases, the longer piece is referred to as a “log.”

In one example embodiment, greenware “logs” 22 can range, for example from 0.9 m to 1 m in length and from about 8 cm to about 22 cm in diameter. Pieces 22 can be generally cylindrical and in another example embodiment have a length of 15″, 25″ or 32″ and a diameter of about 5″. Other sizes and shapes can be accommodated. For example, 12″ long square-cross-section pieces (“loggettes”) 22 or oval-cross-section logs are sometimes used that have a 4″ minor axis and an 8″ major axis. The particular size and shape is ultimately determined by the particular application for the final fired ware.

Pieces 22 initially contain water (e.g., 10-25% by weight) and therefore need to be dried prior to being fired. Pieces 22 are typically placed on trays or supports 24 and then sent through applicator 12 via conveyor 30. Microwave (MW) applicators 12 apply microwave radiation, which as used herein corresponds to electromagnetic (EM) radiation in the frequency range from about 900 MHz to about 2500 MHz. Likewise, RF (radio-frequency) applicators 12 apply RF radiation, which as used herein corresponds to EM radiation in the frequency range of about 27 MHz to about 45 MHz. Both MW and RF radiation are absorbed by pieces 22, albeit to different extents in some cases depending on the greenware composition. Water can thus be driven off by either form of EM radiation, thereby leaving dry (or drier) pieces 22.

Greenware 20 can be made up of material(s) transparent to MW and RF radiation, as well other materials that are not, i.e. MW-susceptible materials such as graphite, as found, for example, in at least some batches and greenware that form aluminum titanate or “AT”. Such AT-based bodies are used as an alternative to cordierite and silicon carbide (SiC) bodies for high-temperature applications, such as automotive emissions control applications. Greenware-containing MW-susceptible material is more prone to the occurrence of hot spots during drying. The systems and methods disclosed herein apply to any type of greenware 20 capable of being dried utilizing EM techniques.

After firing, greenware 20 transforms into a body comprising ceramic material, such as cordierite. In an example embodiment, greenware 20 has an internal structure, such as a honeycomb structure with thin interconnecting porous walls that form parallel cell channels that longitudinally extend between opposite end faces.

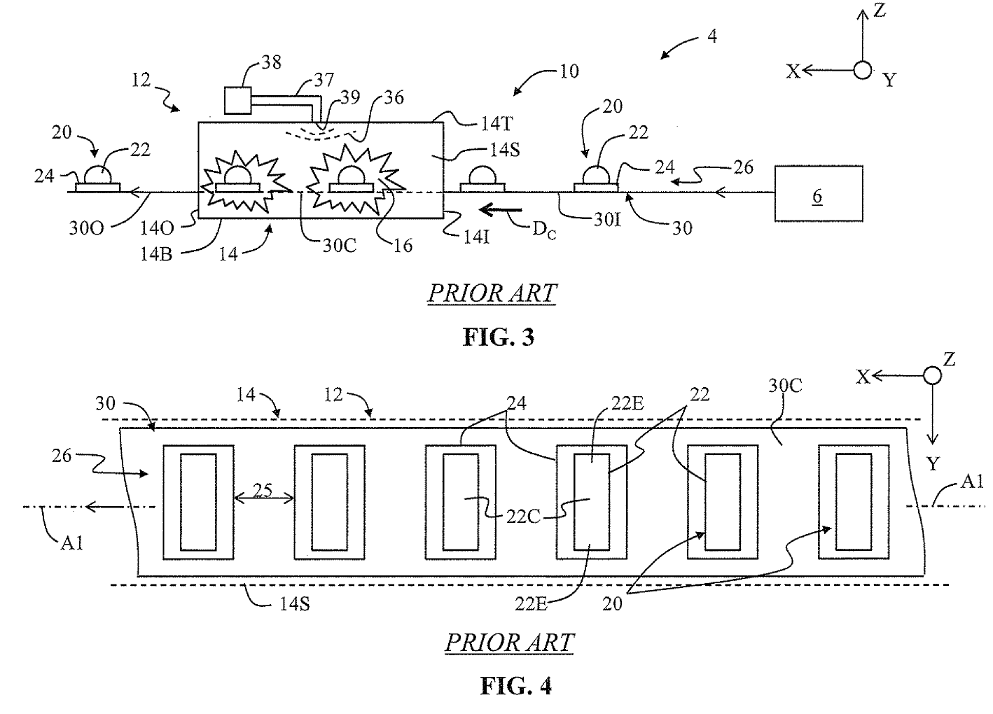

FIG. 3 is a more detailed, side view of the drying system 10 shown in FIG. 2. FIG. 4 is a top-down view of a central section 30C of conveyor system 30, showing greenware supported in trays 24 and moving through applicator 12 in a conveyor direction D_{C}. Cartesian coordinates are shown for the sake of reference, with the Y-axis pointing out of the paper in FIG. 3 and the Z-axis pointing out of the paper in FIG. 4. Conveyor system 30 is shown in FIG. 4 as having a central axis A1. In an example embodiment, conveyor system 30 is capable of moving pieces 22 through applicator 12 in conveyor direction D_{C} at a speed between 0.8 m/min. and 3 m/min. Conveyor direction D_{C} is shown as being in the +X direction.

With reference to FIG. 3 and FIG. 4, applicator 12 has a housing 14 that includes an input end 14I, an output end 14O, a top side (“top”) 14T, a bottom side (“bottom”) 14B, a side 14S, and an interior region 16. These “applicator housing” portions are referred to below simply as applicator portions (e.g., “applicator output end” 14O and “applicator side 14S,” “applicator interior 16,” etc.) for ease of description. An EM source 38 is shown along with an EM waveguide 37 that conveys EM radiation 36 to applicator interior 16 via an EM waveguide end 39. This type of waveguide-based source configuration is typically used for an applicator 12 that employs MW radiation.

Pieces 22 are initially placed in respective trays 24, which are spaced apart by a distance 25 and then conveyed in a greenware queue 26 along conveyor system 30. Pieces 22 each have opposite end portions 22E with a center portion 22C in between. Conveyor system 30 has an input section 301, the aforementioned central section 30C, and an output section 30O that respectively correspond to applicator input end 14I, applicator interior 16 and applicator output end 14O.

In the general operation of drying system 10, pieces 22 are preferably longitudinally aligned in the Y-direction at input end 14I and then conveyed into and through applicator interior 16 in conveyor direction D_{C} by conveyor central section 30C. Pieces 22 are exposed to EM radiation 36 as they pass underneath EM source 38 in applicator interior 16. It is noted here that for most EM applicators 12, EM radiation 36 permeates applicator interior 16 so that pieces 22 are substantially constantly exposed to EM radiation, though perhaps with varying intensity along the conveyed path. Conveyer output section 30O receives pieces 22 conveyed out of applicator output end 14O by conveyor central section 30C.

### Camera Monitoring System

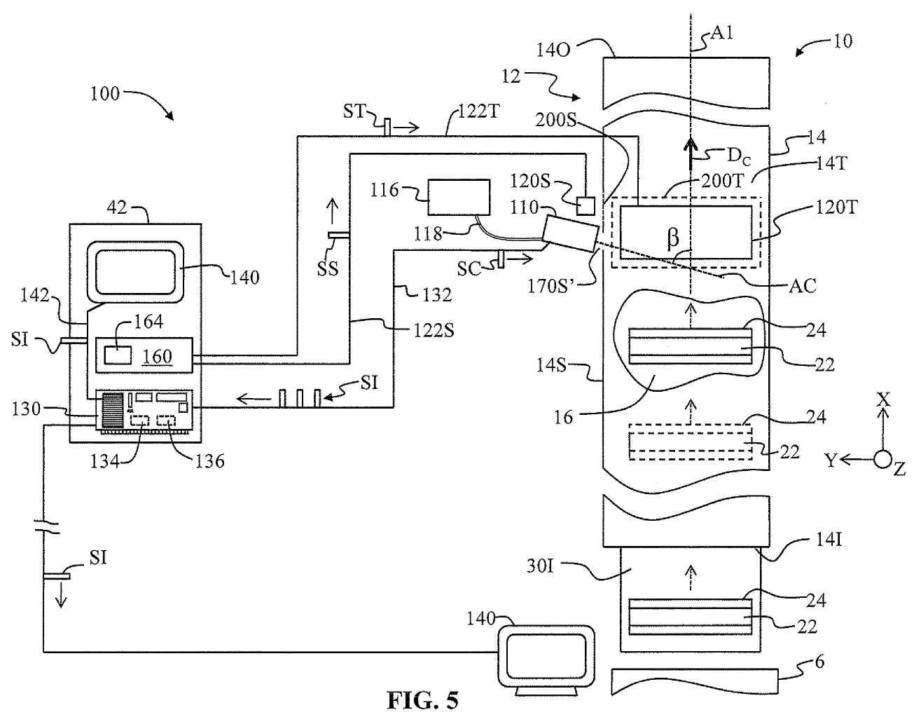

FIG. 5 is a schematic diagram of a camera monitoring system (“system”) 100 that is interfaced with a single-step greenware drying system 10, which is shown in a top-down view. System 100 is used to monitor the drying of pieces 22 in applicator 12. System 100 includes a camera unit 110 operably arranged relative to applicator 12, such as at applicator side 14S as shown, so as to be in optical communication with applicator interior 16 via a camera opening 170S′ in the applicator side, as discussed below. In an example embodiment, camera unit 110 is mounted in a fixed manner to housing 14.

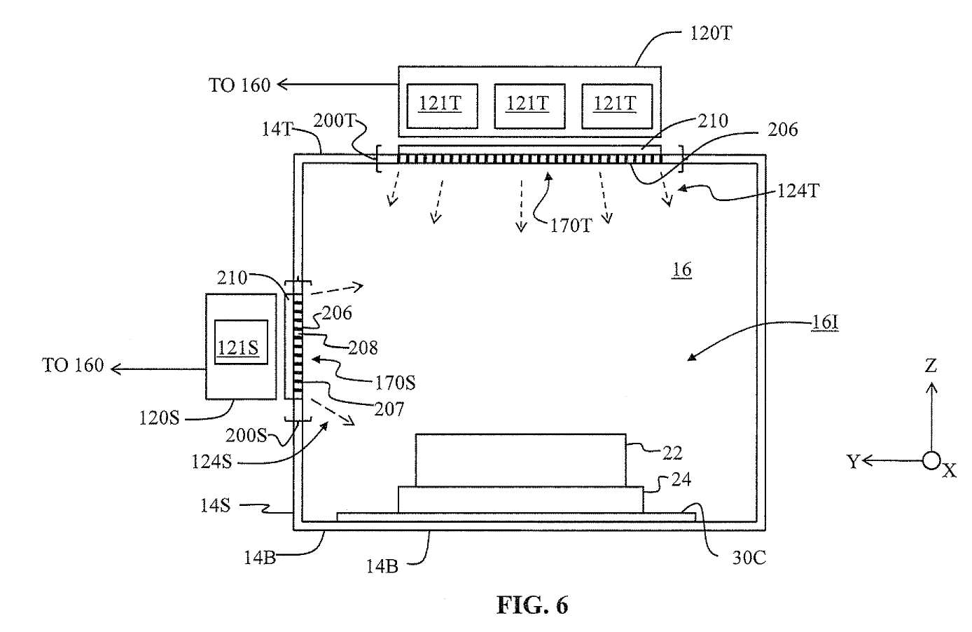

System 100 also includes at least one illuminator unit (“illuminator”) 120 operably arranged relative to applicator 12, to illuminate with visible light a region of interior 16, referred to below as “illuminated region 16I” (see, e.g., FIG. 6). This illumination is provided through at least one EM-reflective window 200 in applicator housing 14. Note that EM-reflective window 200 reflects the EM radiation within applicator interior 16 but transmits visible illumination light. Camera unit 110 is in optical communication with at least a portion of illuminated region 16I through camera opening 170S′. In an example embodiment, system 100 includes two illuminators 120 arranged on different sides of applicator housing 14. In an example embodiment of the two-illuminator arrangement, a side illuminator 120S is operably arranged at applicator side 14S adjacent camera unit 110, and a top illuminator 120T is operably arranged at applicator top 14T. Side illuminator 120S is thus arranged laterally away from conveyor central axis A1. System 100 is discussed below with reference to such a two-illuminator configuration. Details and example embodiments of camera unit 110 are also discussed at greater length below.

With continuing reference to FIG. 5, system 100 also includes a camera controller 130 operably coupled to camera unit 110 via an electrical cable 132 (e.g., a Firewire cable or Ethernet cable) that carries electronic (digital) images as represented by electronic image signals SI. In an example embodiment, camera controller 130 is stored in an electrical cabinet 42 that may include other electrical or electronics equipment. In an example embodiment, camera controller 130 comprises a computer (e.g., a personal computer or workstation) or like machine, that is adapted (e.g., via instructions such as software embodied in a computer-readable or machine-readable medium) to process the electronic images. In an example embodiment, controller 130 includes an operating system such as Microsoft WINDOWS or LINUX. Controller 130 includes an image processing unit (“image processor”) 134 and a memory device or memory unit (“memory”) 136 electrically connected to the image processor and to camera unit 110. Memory 136 is adapted to receive and store electronic images acquired by the camera unit.

In an example embodiment, image processor 134 is or includes any processor or device capable of executing a series of software instructions and includes, without limitation, a general- or special-purpose microprocessor, finite state machine, controller, computer, central-processing unit (CPU), field-programmable gate array (FPGA), or digital signal processor. In an example embodiment, the processor is an Intel XEON or PENTIUM processor, or an AMD TURION or other processor in the line of such processors made by AMD Corp., Intel Corp. or other semiconductor processor manufacturer.

Memory 136 may generally comprise any processor-readable medium, including but not limited to RAM, ROM, EPROM, PROM, EEPROM, disk, floppy disk, hard disk, CD-ROM, DVD, or the like, on which may be stored a series of instructions executable by image processor 134.

With continuing reference to FIG. 5, camera controller 130 is operably connected to at least one display 140 via an electrical (e.g., SVGA) cable 142 so that electronic images captured by camera unit 110 can be displayed in one or more locations. For example, one display 140 is provided in electrical cabinet 42 which is relatively close to to applicator 12, while another display 140 is provided more remote to the applicator, such as near extruder 6 as shown. Such positioning of another display 140 allows for observing drying defects at an early stage by those monitoring the upstream extrusion process. An advantage of having a display 140 close to applicator 12 is that the operators and/or process engineers have direct feedback to the drying process happening close by and can more quickly make any changes to the applicator.

In an example embodiment, camera controller 130 passes electronic images (embodied in electronic image signals SI) directly from camera unit 110 to display 140, while in another example embodiment the camera controller processes the electronic images first using image processor 134, as described below. A suitable display 140 is a Samsung 32″ LCD monitor Model No. SM320PX.

System 100 also includes an adjustable power supply unit 160 electrically connected to side illuminator 120S via an electrical cable 122S and electrically connected to top illuminator 120T via an electrical cable 122T. Adjustable power supply unit 160 includes a lighting control box 164 configured to control the operation of side and top illuminators 120S and 120T by adjusting the amount of power provided to the illuminators. In an example embodiment, adjustable power supply unit 160 is also optionally included in applicator system electrical cabinet 42, as shown

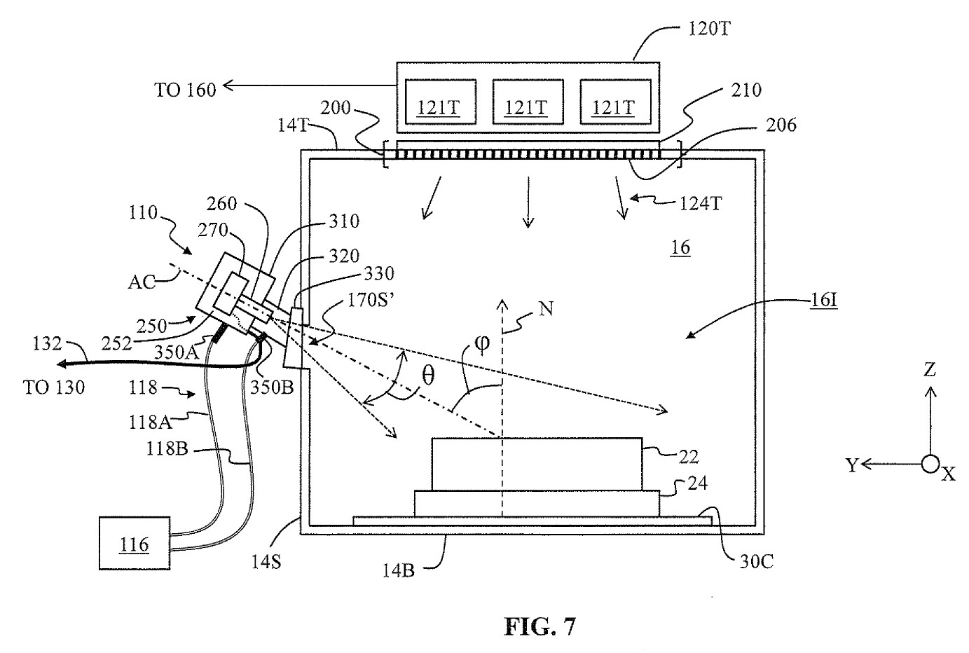

FIG. 6 is a close-up, input-end view of applicator 12 that shows more details of side and top illuminators 120S and 120T. FIG. 7 is similar to FIG. 6, but shows camera unit 110 and only top illuminator 120T, with the side illuminator 120S being omitted for ease of illustration. With reference to FIG. 6, side illuminator 120S is arranged at applicator side 14S adjacent an opening 170S formed therein. Likewise, top illuminator 120T is arranged at applicator top 14T adjacent a top opening 170T formed therein. Side illuminator 120S is configured to generate visible light 124S and top illuminator 120T is configured to generate visible light 124T. In an example embodiment, side and top illuminators 120S and 120T are respectively attached to (e.g., mounted to) applicator side 14S and applicator top 14T.

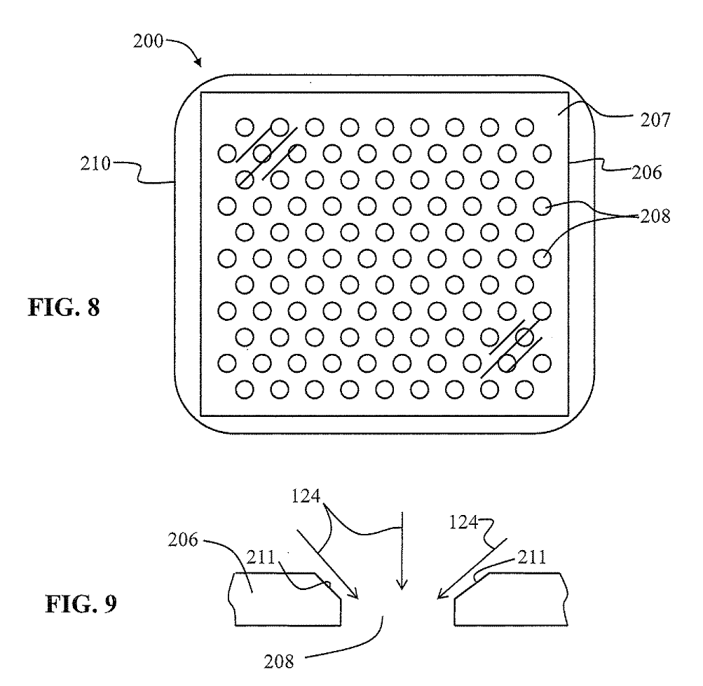

Side and top openings 170S and 170T are respectively covered by EM-reflecting windows 200, namely a side window 200S and a top window 200T. Each of these windows is configured to reflect substantially all of the EM-radiation incident thereon back into applicator interior 16 while also transmitting visible illumination light 124. FIG. 8 shows a plan view of an example EM-reflecting window 200 that includes an EM-reflecting screen 206 covered on the side opposite applicator interior 16 by a glass plate 210. An example EM-reflecting screen 206 is made of a metal plate (e.g., an aluminum plate) having a body portion 170 with a periodic array of holes 208 formed therein. Holes 208 are sized so that the metal body 207 acts to reflect the particular EM radiation (i.e., MW or RF radiation), while the holes transmit a substantial portion of visible illumination light 124. In an example embodiment, EM-reflecting screen 206 is about 5 mm thick and has holes 208 of about 5 mm in diameter, and glass plate 210 is about 5 mm thick. The precise size of holes 208 depends on the particular frequency range of the EM radiation used by applicator 12. The inventor has found that the 5 mm diameter hole size works well for MW radiation.

FIG. 9 is a close-up, cross-sectional view of EM-reflecting screen 206, wherein holes 208 include a countersink 211 to facilitate a greater range of angles of illumination light 124, thereby increasing the transmission of illumination light through the EM-reflecting screen.

In an example embodiment of top window 200T, glass plate 210 has dimensions of about 18 cm by 36 cm, while EM-reflecting screen 206 has dimensions of about 15 cm by 33 cm. In an example embodiment, top opening 170T is located at or near housing output end 14O (e.g., from about 5 cm to about 20 cm from the output end). In the case of an applicator 12 that utilizes RF radiation generated by an electrode adjacent applicator top 14T, there is usually about 2 ft (i.e., about 61 cm) of space between applicator output end 14O and the RF electrode (not shown), which provides ample room for positioning top illuminator 120T.

It is also noted that for an applicator 12 that utilizes MW radiation, the MW radiation is typically provided via a microwave guide, such as microwave guide 37 described above in connection with FIG. 3. Since the microwave guide end 39 is relatively small, there is usually no problem finding a suitable location for top opening 170T. In an example embodiment, side and top illuminators 120S and 120T and camera unit 110 are located closer to applicator output end 14O than to applicator input end 14I so that pieces 22 are more dry when they pass through illuminated region 161 and are imaged by camera unit 110.

In an example embodiment, side openings 170S and 170S′ are located between ⅓ and ½ of the way up from applicator bottom 14B. By way of example, for a housing 14 that is essentially square, with 2 m long sides, an example center position of side openings 170S and 170S′ is about 60 cm from applicator bottom 14B.

In an example embodiment, top illuminator 120T is disposed downstream of where piece 22 enters the field of view of camera 260. This arrangement assures that the portion of piece 22 that faces in the +X direction is directly illuminated and that camera unit 110 images this illuminated portion by facing at least partially in the −X direction.

In an example embodiment of side window 200S, glass plate 210 has dimensions of about 15 cm by 23 cm, and EM-reflecting screen 206 has slightly smaller dimensions. In an example embodiment, side opening 170S is located at or near housing output end 14O (e.g., from about 5 cm to about 20 cm from the output end) and is also located closer to applicator bottom 14B than to applicator top 14T.

In an example embodiment, side illuminator 120S and/or top illuminator 120T include(s) one or more lamp units 121 that generate visible illumination light 124. FIG. 7 illustrates an example embodiment where top illuminator 120T includes three lamp units 121T for generating visible illumination light 124T. An example lamp unit 121 suitable for use in side and top illuminators 120S and 120T is light-emitting-diode- (LED-)based, such as the POWER-LINE 1TE by Buechner Lichtsysteme GmbH, Germany. In an example embodiment, at least one of illuminator 120 includes at least one array of LEDs.

One benefit of using one or more LED-based lamp units 121 is that it avoids the use of alternating current (AC), which can cause flicker when capturing electronic images at a rate that is a substantial fraction of the conventional AC lighting frequency of 60 Hz. In an example embodiment, red-wavelength LEDs are used because of their relatively long lifetime and relatively high brightness.

With reference now to FIG. 7, camera unit 110 is operably arranged (e.g., mounted) to applicator side 14S adjacent side illuminator 120S. As discussed above, applicator side 14S includes camera opening 170S′ through which camera unit 110 views a portion of applicator interior 16 (and in particular at least a portion of illumination region 16I therein). In an example embodiment, camera unit 110 includes a camera-unit housing 250 that defines a camera-unit housing interior 252, which contains a camera lens 260 with an optical axis AC. Camera lens 260 is optically coupled to an image sensor 270 adapted to capture an electronic image of the real image formed by the camera lens. An example camera lens 260 suitable for use in camera unit 110 is a Pentax H1214-M (C6123) machine vision mega-pixel lens having a 12 mm focal length, ½ format, an F/# of F/1.4, and a horizontal field of view θ of about 29°. An example image sensor 270 is a standard charge-coupled device (CCD) array for commercial or industrial digital cameras. In an example embodiment, camera unit 110 is configured so that camera lens axis AC forms a viewing angle φ as measured in (i.e., as projected onto) the Y-Z plane, e.g., with respect a conveyor normal vector N directed in the vertical or Z-axis direction. In an example embodiment, 70°≦φ≦80°. Also, with reference also to FIG. 5, in an example embodiment, camera lens axis AC forms an angle β as measured in (i.e., as projected onto) the X-Y plane with respect to conveyor direction D_{C} and is preferably in the range 80°≦β≦100°, and is more preferably within a few degrees of 90°.

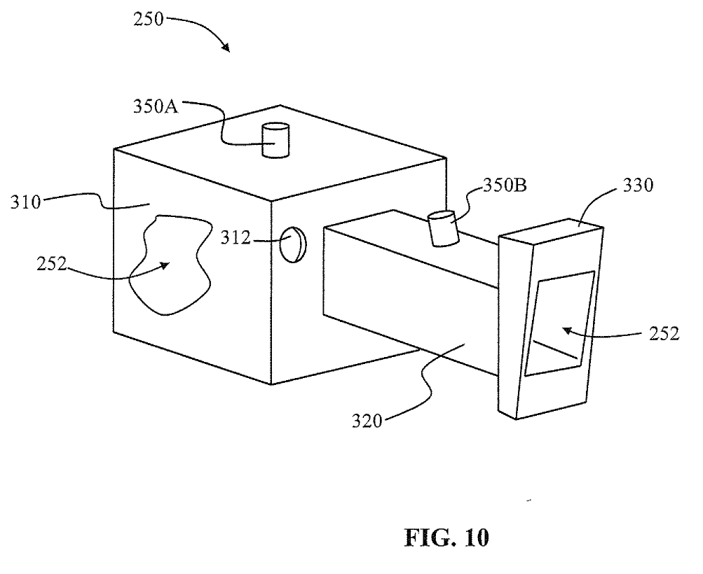

FIG. 10 is a perspective front-end view of an example embodiment of camera-unit housing 250 that defines a camera-unit housing interior 252. Camera-unit housing 250 includes a main section 310 and an EM-blocking channel section 320 that connects the main housing to applicator side 14S at camera opening 170S′. In an example embodiment, camera-unit housing 250 includes an angled mounting plate 330 at the end of EM-blocking section 320 that contacts applicator housing 14. Angled mounting plate 330 facilitates maintaining camera lens optical axis AC at the aforementioned viewing angles φ and β.

EM-blocking channel section 320 is configured to substantially prevent EM radiation 36 within applicator interior 16 from reaching camera lens 260. In an example embodiment suitable for MW radiation, EM-blocking channel section 320 is formed from metal (e.g., aluminum) and has a 2″×2″ (i.e., 5.08 cm×5.08 cm) square cross-section. Note that in for this example embodiment, camera opening 170S′ in applicator side 14S would also be about 2″×2″ square. In an example embodiment, the front of camera lens 260 is about 6″ (i.e., about 15.24 cm) from the camera opening 170S′.

With reference also to FIG. 7, camera unit housing 250 is fluidly connected to a fluid source 116 via a fluid line system 118. In an example embodiment, fluid source 116 provides a gas such as compressed air, or an inert gas such as nitrogen. Camera-unit housing 250 includes a first fluid-line connector 350A at main housing section 310 that connects to a first fluid line 118A, and a second fluid-line connector 350B at EM-blocking channel section 320 that connects to a second fluid line 118B. In an example embodiment, fluid flows around camera-unit housing 250, while in another example embodiment the fluid flows within camera housing interior 252. In another example embodiment, fluid flows both around the outside and within the inside (interior 252) of camera-unit housing 250.

The fluid provided to main housing section 310 via first fluid line 118A serves to cool camera lens 260 and image sensor 270. This cooling is needed because applicator 12 heats up to a temperate of about 60° C., and this heat is conducted to camera unit 110 via camera-unit housing 250. Most image sensors 270 need to operate at relatively cool temperatures (e.g., 40° C. or below).

The fluid provided to camera-unit housing 250 at EM-blocking section 320 via second fluid line 118B serves to maintain a flow of fluid from camera-unit housing interior 252 into applicator interior 16. This substantially prevents moisture from applicator interior 16 from reaching camera lens 260 and condensing on the outermost lens element, which would fog the lens and reduce imaging quality. To ensure the proper direction of fluid flow, in an example embodiment, second fluid-line connector 350B is angled so that the initial flow of fluid is down EM-blocking channel section 320 and towards applicator interior 16. In an example embodiment, two fluid lines 118B and two angled fluid-line connectors 350B on opposite sides of EM-blocking channel section 320 are used to ensure the proper direction and volume of fluid flow.

Main housing section 310 includes a hole 312 used to run electrical cable 132 from camera unit 110 (and in particular, image sensor 270) to camera controller 130. In an example embodiment, a sealed feed-through connector (not shown) is used to seal hole 312 when cable 132 (not shown in FIG. 10) is feed therethrough so that dust and other matter cannot make its way into camera-unit housing interior 252.

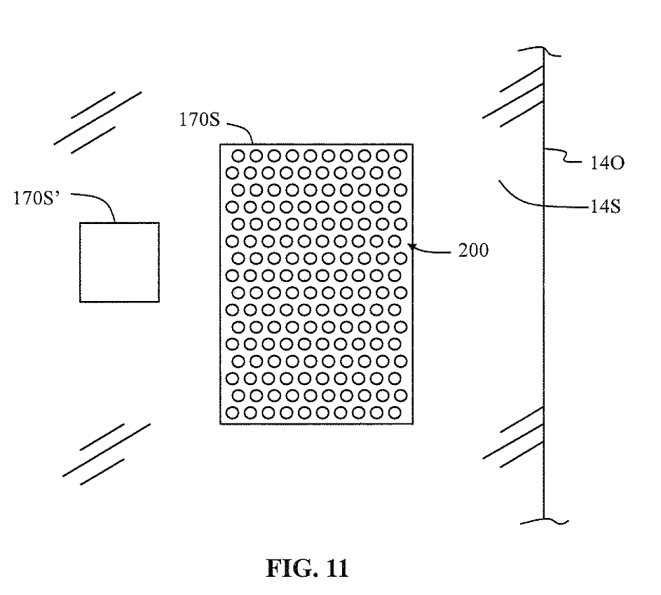

FIG. 11 is a view of applicator side 14S as seen from applicator interior 16 and shows an example configuration of the side illuminator opening 170S and camera opening 170S′. Side window 200S can be seen through illuminator opening 170S. The proximity of camera unit 310 to side illuminator 120S facilitates the capture of electronic images of pieces 22 as they pass through illuminated region 16I.

### Method of Operation

Camera monitoring system 100 serves to monitor in real time the drying process in greenware dryer system 10 by capturing and displaying (and/or processing) electronic images of pieces 22 as they are conveyed through applicator interior 16 while being subjected to EM radiation 36. Thus, once the operation of greenware-forming system 4 is initiated and pieces 22 start to be conveyed through dryer system 10 via conveyor 30, camera monitoring system 100 is activated. This involves activating image sensor 270 (e.g., via a control signal SC from camera controller 130) and activating side and top illuminators 120S and 120T with respective control signals SS and ST via lighting control box 164 by dialing up the power provided to the illuminators.

The activation of side illuminator 120S generates visible light 124S that passes through side window 200S and illuminates a region within applicator interior 16. Likewise, the activation of top illuminator 120T generates visible light 124T that passes through top window 200T and preferably illuminates at least a portion of the same region of applicator interior 16 illuminated by light 124S. The result is the formation of the aforementioned illuminated region 16I within applicator interior 16. As discussed above, in an example embodiment, illuminated region 16I is preferably formed at or near applicator output end 14O. This location is advantageous because piece 22 being conveyed through applicator interior 16 is more dry at applicator output end 14O than at the center or input end 14I and so is more likely to outwardly manifest any drying defects.

As pieces 22 are conveyed by central conveyor section 30C through applicator interior 16, each passes through illuminated region 16I. At this point, an image of the greenware piece 22 within the field of view of camera lens 260 is formed on image sensor 270, which converts the light image into an electronic image. In an example embodiment, a series of electronic images of piece 22 are captured (e.g., at a rate in the range between 20 and 40 images/second, inclusive, such as at a rate of 30 images/second) and sent to computer controller 130 via electronic image signals SI, which are stored in memory 136, processed by image processor 134, and/or displayed on display 14O. It is noted here that in an example embodiment, an electronic image of piece 22 does not need to capture the entire piece, but rather can capture just a portion of the piece sufficient to discern at least one drying defect. In this regard, in an example embodiment, camera lens 260 has zoom capability so that close-up views can be obtained of portions of piece 22 to more closely view and identify potential drying defects.

In another example embodiment, camera lens 260 has a magnification that shows pieces 22 larger than they actually are. This facilitates detecting small drying defects, e.g., drying defects as small as about 2 mm. In an example embodiment, camera lens 260 captures an entire piece 22 (i.e., the entire length of the piece) in the field of view.

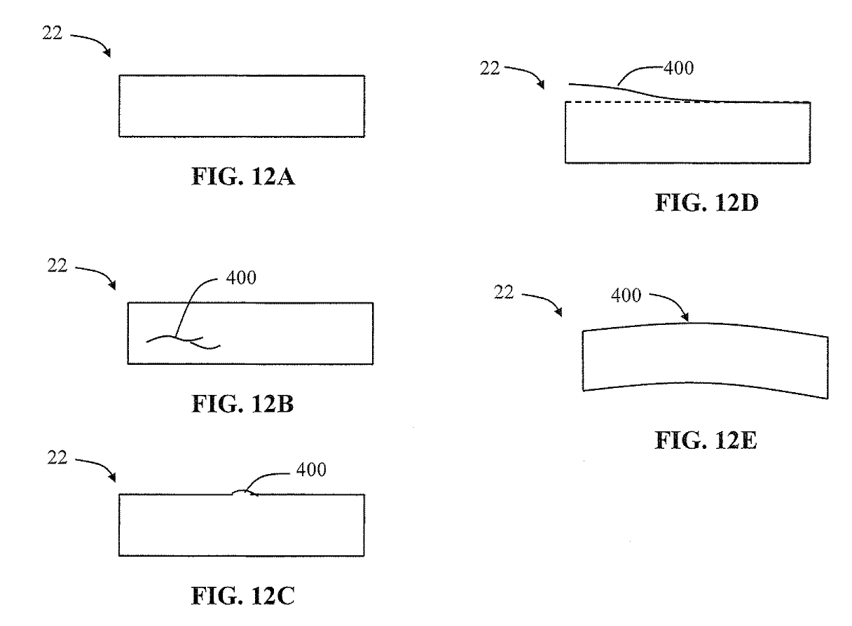

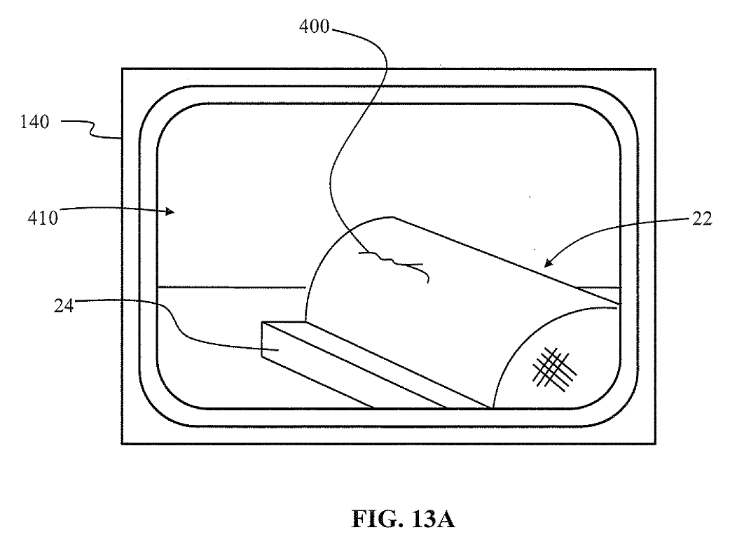

Electronic images are also provided to display 14O from camera computer 130 via electronic image signals SI so that one or more operators can view a displayed image of the particular piece 22 being monitored and examine it for drying defects. FIG. 12A is a schematic side view of an example “ideal” greenware piece 22 that has no visible drying defects. FIGS. 12B-12E are similar to FIG. 12A and illustrate different examples of visible drying defects 400 as might be seen when viewed with the camera monitoring system 100 of the present invention. The displayed electronic image needs to have sufficient resolution to show the more important surface defects, such as cracking (FIG. 12B), bubbling (FIG. 12C), separation of the “skin” from the body of the piece (FIG. 12D), as well as the larger-scale defects, such as bowing (FIG. 12E). In an example embodiment, electronic images have a resolution capable of resolving a greenware drying defect having a size (e.g., a visible median diameter, for example, or a visible median width) of 2 mm or greater.

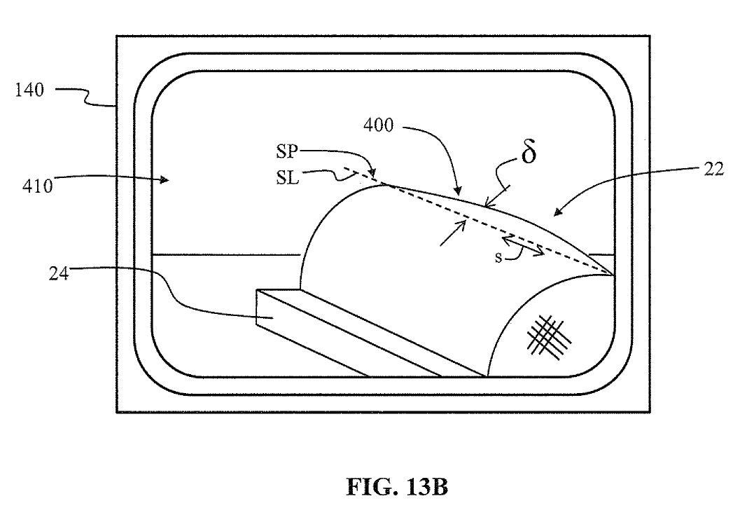

FIG. 13A is a schematic diagram of an example displayed (electronic) image 410 of piece 22 as displayed on display 14O. Displayed image 410 shows a visible drying defect 400 in the form of a crack or fissure. FIG. 13B is similar to FIG. 13A and illustrates an example displayed image 410 of piece 22 showing a visible drying defect 400 in the form of an “up/down” bow.

In an example embodiment, image processor 134 is adapted (e.g., via instructions such as software embodied in a computer-readable or machine-readable medium such as memory 136) to perform image processing of the electronic images to automatically characterize or detect at least one drying defect 400. In an example embodiment, the image processing of the electronic images involves comparing one or more geometrical aspects of an electronic image of a piece 22 to that of an archetypal greenware piece, to a reference line, to a reference point or to a reference shape.

In an example embodiment for measuring an amount of a bow-type drying defect 400, image processor 134 measures and calculates an amount of“left/right” bow (i.e., bending in the X-Y plane) as well as “up/down” bow (i.e., bending in the X-Y plane). With reference to FIG. 13B, in one example embodiment, the amount of bow is measured by electronically projecting a shape SP, such as a straight line SL as shown, relative to displayed image 410 of piece 22. A measurement is then made relative to projected shape SP. In the example shown in FIG. 13B, the measurement is a deviation (distance) δ (in mm) between projected straight line SL and piece 22 at one or more locations along the length s of the projected line. The deviation δ is then compared to an acceptable amount of bow, i.e., a bow tolerance δ_{T}. An example value for the bow tolerance δ_{T} is 2 mm. In an example embodiment, the measured amount δ of bow as a function of the distance s along the projected line SL (i.e., δ(s) is shown in a graphical display on display 14O. This provides information not only of the magnitude of the bow, but the shape characteristics of the bow as well. This, in turn, reveals information about the drying process.

In an example embodiment, image processor 134 is adapted to measure the alignment of pieces 22 to one or more reference points (e.g., to each other), including measuring the distance 25 between pieces. Such measurements are important because drying uniformity depends in part on the orientation of pieces 22 in applicator 12, the distance 25 and the uniform spacing between the pieces.

It will be apparent to those skilled in the art that various modifications to the example embodiments of the invention as described herein can be made without departing from the spirit or scope of the invention as defined in the appended claims. Thus, it is intended that the present invention covers the modifications and variations of this invention provided they come within the scope of the appended claims and the equivalents thereto.

What is claimed is:

1. A camera monitoring system for monitoring the drying of greenware in an applicator having a housing that defines an applicator interior and employing microwave or radio-frequency electromagnetic (EM) radiation, the system comprising:
at least one illuminator arranged relative to the applicator housing and configured to provide illumination to the applicator interior through at least one corresponding EM-reflective side window to form an illuminated region within the applicator interior through which the greenware pass;
a camera unit arranged relative to the applicator housing and aligned with an opening formed in the housing, the camera unit being operable to capture electronic images of the greenware as they pass through the interior illuminated region, said electronic images having sufficient resolution to resolve at least one greenware drying defect; and
at least one display operably connected to the camera unit and operable to display one or more of the electronic images.

2. The camera monitoring system of claim 1 further comprising first and second illuminators arranged on first and second sides of the applicator housing.

3. The camera monitoring system of claim 2 wherein the camera unit is arranged adjacent one of the first and second illuminators.

4. The camera monitoring system of claim 1 wherein:
the camera unit comprises an image sensor and a camera lens optically coupled thereto, and a camera-unit housing that defines an interior containing the image sensor and camera lens, with the camera-unit housing including an EM-blocking section that substantially prevents the EM radiation from entering the camera-unit housing interior from the applicator interior.

5. The camera monitoring system of claim 4 wherein the camera-unit housing is pneumatically connected to a gas supply and is configured to perform at least one of:
a) flowing gas around the image sensor to cool the image sensor; and
b) flowing gas substantially in the direction from the camera-unit housing interior to the applicator interior.

6. The camera monitoring system of claim 1 further comprising:
a camera controller operably connected to the camera unit and having a processor operably connected to a memory unit, wherein the memory unit is configured to store electronic images of the greenware, and the processor is configured to processes the stored electronic images to identify at least one greenware drying defect.

7. The camera monitoring system of claim 1 wherein the at least one drying defect includes at least one of: bowing, cracking, bubbling and separation.

8. The camera monitoring system of claim 1 wherein the at least one EM-reflective window comprises an EM-reflective screen facing the applicator interior, and a glass plate covering the EM-reflective screen on a side opposite the applicator interior.

9. The camera monitoring system of claim 1 wherein the at least one illuminator comprises one or more arrays of light-emitting diodes.

10. The camera monitoring system of claim 1 wherein the camera unit captures electronic images at a rate of 20 to 40 images per second.

11. The camera monitoring system of claim 1 wherein the applicator housing has an input end and an output end, and wherein at least one illuminator and the camera unit are arranged closer to the output end than to the input end.

12. The camera monitoring system of claim 1 wherein the applicator housing has a bottom, and wherein the camera unit is arranged closer to the bottom than to the top.

13. A method of monitoring the drying of greenware via microwave or radio-frequency electromagnetic (EM) radiation in an applicator having a housing that defines an applicator interior, the method comprising:
forming an illuminated region in the applicator interior by passing illumination from outside the applicator housing through at least one EM-reflecting window of the applicator housing;
arranging a camera unit having an image sensor and a camera lens outside of the applicator and adjacent an opening in the applicator housing so that the camera unit is in optical communication with the illuminated region through an EM-blocking structure that substantially prevents EM radiation from reaching the camera lens;
passing the greenware through the illuminated region; and
capturing and displaying electronic images of the greenware as they pass through the illuminated region, said electronic images having a resolution capable of resolving at least one greenware drying defect.

14. The method of claim 13 wherein the image sensor and camera lens are contained in an interior of a camera-unit housing, and the method further comprises performing at least one of:
a) flowing a fluid around the image sensor to cool the image sensor; and
b) flowing a fluid substantially in the direction from the camera-unit housing interior to the applicator interior to substantially prevent water vapor from the applicator interior from reaching the camera lens.

15. The method of claim 13 further comprising:
performing image processing of at least one of the electronic images to identify the at least one greenware drying defect.

16. The method of claim 13 wherein the applicator housing has an input end and an output end, and the method further comprises:
forming the illuminated region closer to the output end than to the input end.

17. A camera monitoring system for monitoring the drying of greenware via microwave or radio-frequency electromagnetic (EM) radiation in an applicator having a housing with a side, a top and an interior, the method comprising:
side and top illuminators respectively arranged adjacent the applicator housing side and top and respectively operatively configured to provide illumination to the applicator interior through respective EM-reflective side and top windows to form an interior illuminated region through which the greenware pass while being exposed to the EM radiation;
a camera unit arranged adjacent the side illuminator and aligned with an opening formed in the housing, the camera unit positioned and adapted to capture electronic images of the greenware as they pass through the interior illuminated region, said electronic images having sufficient resolution to resolve at least one greenware drying defect; and
at least one display operably connected to the camera unit and configured to display one or more of the electronic images.

18. The camera monitoring system of claim 17 wherein the camera unit comprises an image sensor and a camera lens optically coupled thereto, and the camera-unit housing defines an interior that contains the image sensor and camera lens, the camera-unit housing comprising an EM-blocking channel section that substantially prevents the EM radiation from entering the camera-unit housing interior from the applicator interior.

19. The camera monitoring system of claim 17 wherein the camera-unit housing is pneumatically connected to a gas supply so that gas from the gas supply flows substantially in one direction from the camera-unit housing interior to the applicator interior.

20. The camera monitoring system of claim 17 further comprising a camera controller having a processor operably coupled to a memory unit, wherein the memory unit stores electronic images of the greenware, and the processor is configured to process the electronic images to identify the at least one greenware drying defect.
